(19) United States
(12) Patent Application Publication
(10) Pub. No.: US 2011/0142438 A1
(43) Pub. Date: Jun. 16, 2011

(54) PROTECTION SWITCHING METHOD IN OPTICAL TRANSPORT NETWORK

(75) Inventors: Ji Wook YOUN, Daejeon (KR); Bup Joong KIM, Daejeon (KR); Hong Ju KIM, Daejeon (KR)

(73) Assignee: Electronics and Telecommunications Research Institute, Daejeon (KR)

(21) Appl. No.: 12/964,105

(22) Filed: Dec. 9, 2010

(30) Foreign Application Priority Data
Dec. 14, 2009 (KR) 10-2009-0124146
Aug. 19, 2010 (KR) 10-2010-0080503

(51) Int. Cl. H04J 14/00; H04B 10/00

(52) U.S. Cl. 398/5; 398/51

(57) ABSTRACT

In an optical transport network for packet transmission, at least one tunnel for providing an end-to-end connection between nodes is formed, and the tunnel includes at least one optical wavelength. A plurality of optical channels are allocated to each optical wavelength, and one optical channel is set up as an optical channel for protection switching for the tunnel. If a failure occurs in an optical channel in packet transmission, packets are transmitted through the optical channel for protection switching set up for the corresponding tunnel.

### CROSS-REFERENCE TO RELATED APPLICATION

This application claims priority to and the benefit of Korean Patent Application No. 10-2009-0124146 and 10-2010-0080503 filed in the Korean Intellectual Property Office on Dec. 14, 2009 and Aug. 19, 2010, the entire contents of which are incorporated herein by reference.

### BACKGROUND OF THE INVENTION

(a) Field of the Invention

The present invention relates to a protection switching method in an optical transport network.

(b) Description of the Related Art

An optical transport network has a wide bandwidth, a high level of reliability, a well-developed protection switching function, and uses operation, administration, and maintenance (OAM) technology. Accordingly, research on transportation of packet data, which is experiencing explosive growth at present, over an optical transport network, is actively ongoing.

The conventional packet transmission using the optical transport network is disadvantageous in that it cannot provide a function of effective protection switching of packet data because the packet data is simply multiplexed into a time division multiplexing (TDM) signal with a high transmission rate, which is then transmitted via the optical transport network.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for performing a protection switching function differentiated for each channel in an optical transport network.

An exemplary embodiment of the present invention provides a protection switching method in an optical transport network including a plurality of nodes between which packets corresponding to at least one service group are transmitted and received, the method including: forming an end-to-end connection by providing at least one tunnel for one service group, the tunnel including at least one optical wavelength; allocating a plurality of optical channels to the optical wavelength; and setting up at least one of the plurality of optical channels as an optical channel for protection switching of the service group.

Here, one tunnel may be provided for one service group, the tunnel including a plurality of optical wavelengths. In this case, in the setting up, one of the plurality of optical channels for each optical wavelength may be set up as an optical channel for protection switching of the service group.

Furthermore, one tunnel may be provided for one service group, the tunnel including a plurality of optical wavelengths. In this case, in the setting up, all of the plurality of optical channels corresponding to one of a plurality of optical wavelengths may be set up as optical channels for protection switching of the service group.

Furthermore, a plurality of tunnels may be provided for one service group, each of the tunnels including a different optical wavelength. In this case, in the setting up, one of the plurality of optical channels corresponding to the optical wavelength may be set up as an optical channel for protection switching of the service group.

Another exemplary embodiment of the present invention provides a protection switching method in an optical transport network including a plurality of nodes between which packets corresponding to at least one service group are transmitted and received, the method including: forming an end-to-end connection by providing respective tunnels for different service groups, the tunnels of the different service groups including the same single optical wavelength; allocating a plurality of optical channels to the single optical wavelength; and selecting one of the plurality of optical channels for each service group and setting up the same as an optical channel for protection switching of each service group.

### BRIEF DESCRIPTION OF THE DRAWINGS

FIG. 1 is a view showing a method of configuring a tunnel in an optical transport network according to an exemplary embodiment of the present invention.

FIG. 2 is a view showing a structure of an optical transport network having a protection switching function according to the exemplary embodiment of the present invention.

FIG. 3 is a view showing a mapping relation between service groups and tunnels in the optical transport network according to the exemplary embodiment of the present invention.

FIG. 4 is a flowchart showing a protection switching method in an optical transport network according to a first exemplary embodiment of the present invention.

FIG. 5 is an illustration of the application of the protection switching method according to the first exemplary embodiment of the present invention.

FIG. 6 is a flowchart showing a protection switching method in an optical transport network according to a second exemplary embodiment of the present invention.

FIG. 7 is an illustration of the application of the protection switching method according to the second exemplary embodiment of the present invention.

FIG. 8 is a flowchart showing a protection switching method in an optical transport network according to a third exemplary embodiment of the present invention.

FIG. 9 is an illustration of the application of the protection switching method according to the third exemplary embodiment of the present invention.

FIG. 10 is a flowchart showing a protection switching method in an optical transport network according to a fourth exemplary embodiment of the present invention.

FIG. 11 is an illustration of the application of the protection switching method according to the fourth exemplary embodiment of the present invention.

### DETAILED DESCRIPTION OF THE EMBODIMENTS

Hereinafter, exemplary embodiments will be described in detail to enable those skilled in the art to readily practice the present invention. While describing the present invention in detail, detailed descriptions of related well-known functions or configurations that may obscure the description of the present invention will be omitted. In the accompanying drawings, elements having similar functions and operations are denoted by the same reference numerals.

It will be understood that when an element is referred to as being “connected with” another element, it can be directly connected with the other element or intervening elements may also be present. In addition, unless explicitly described to the contrary, the word “comprise” or “include” and variations such as “comprises”, “comprising”, “includes”, and “including” will be understood to imply the inclusion of stated elements but not the exclusion of any other elements.

Now, a protection switching method in an optical transport network and an apparatus therefor according to an exemplary embodiment of the present invention will be described with reference to the accompanying drawings.

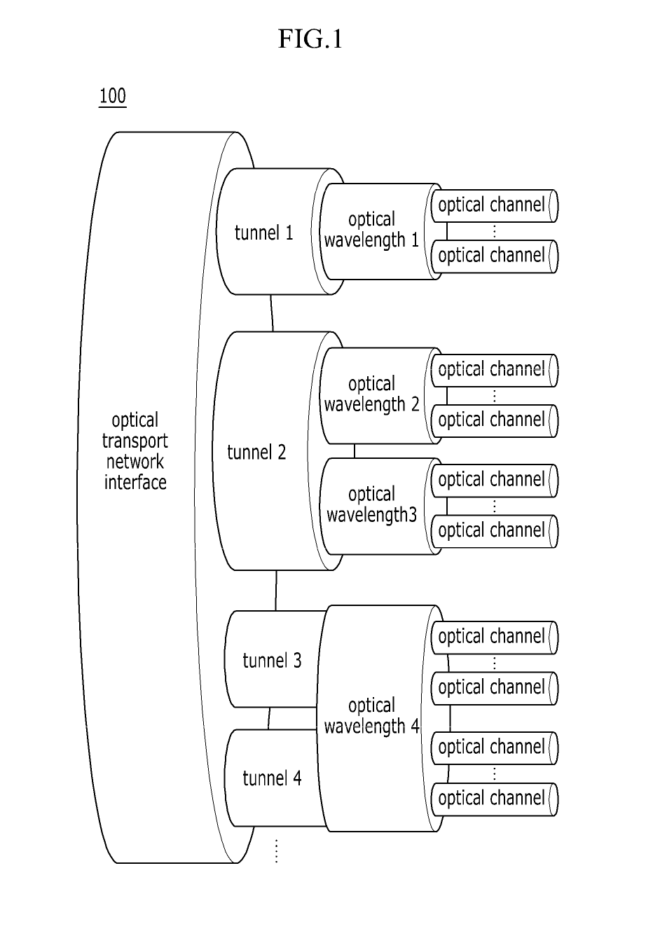

FIG. 1 is a view showing a method of configuring a tunnel in an optical transport network according to an exemplary embodiment of the present invention.

As shown in the accompanying FIG. 1, an optical transport network 100 consists of a plurality of tunnels. Each tunnel represents a logical connection path that provides an end-to-end connection.

These tunnels can be configured in the following 3 ways:

1. one tunnel includes one optical wavelength;

2. one tunnel includes a plurality of optical wavelengths; and

3. a plurality of tunnels include one wavelength.

One optical wavelength includes at least one optical channel. An optical channel may include any of ODU (optical channel data unit), VC (virtual container), VCG (virtual concatenation group), and IP/service flow depending on what type of physical link it uses, and may be configured in various manners depending on the type of physical link. In the exemplary embodiment of the present invention, bandwidth allocation and protection switching functions may be applied differently for each optical channel.

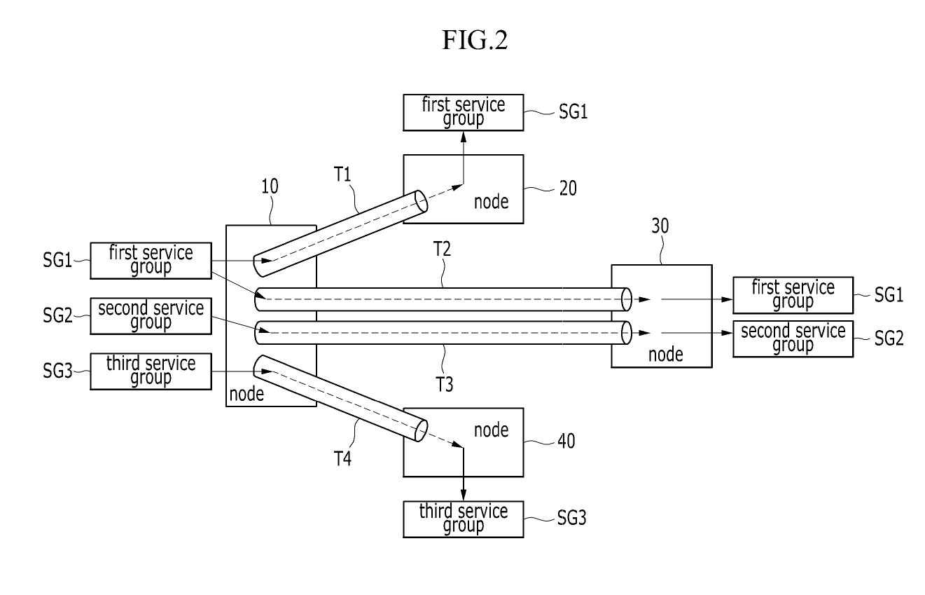

FIG. 2 is a view showing a structure of an optical transport network having a protection switching function according to the exemplary embodiment of the present invention. Although FIG. 2 illustrates an example where four nodes, three service groups, and four tunnels are used in the optical transport network 100, the present invention is not limited thereto.

In the optical transport network 100 according to the exemplary embodiment of the present invention, a plurality of nodes 10 to 40 are connected via at least one tunnel, and each of the nodes represents an optical transport network device. Tunnels T1 to T4 provide end-to-end connection between the nodes. For example, tunnel T1 and tunnel T2 provide VPN (virtual private network) A, tunnel T3 provides VPN B, and tunnel T4 provides VPN C.

An optical transport network device, i.e., each of the nodes 10 to 40, can transmit and receive packets corresponding to at least one service group SG1 to SG3. The service groups SG1 to SG3 provide packets corresponding to one of all kinds of services, such as VPN service or leased network service, irrespective of the type of service.

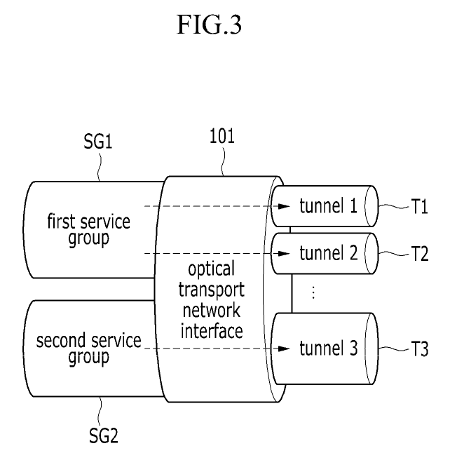

FIG. 3 is a view showing a mapping relation between service groups and tunnels in the optical transport network according to the exemplary embodiment of the present invention.

Service groups SG1 to SG3 can be mapped to at least one tunnel, and, as illustrated in FIG. 3, the first service group SG1 can be mapped to tunnel T1 and tunnel T2 through an optical transport network interface 101, and the second service group SG2 can be mapped to tunnel T3 through the optical transport network interface 101.

Next, a protection switching method in an optical transport network according to a first exemplary embodiment of the present invention will be described.

In the optical transport network according to the first exemplary embodiment of the present invention, one tunnel includes one optical wavelength, and the optical wavelengths of each tunnel are different from each other.

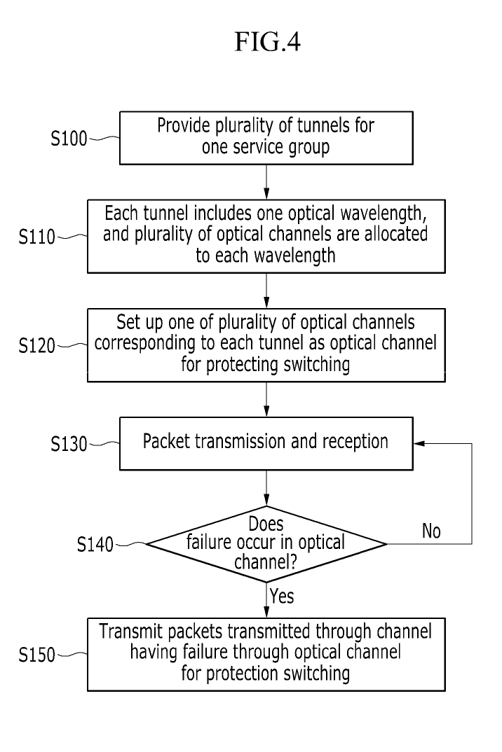

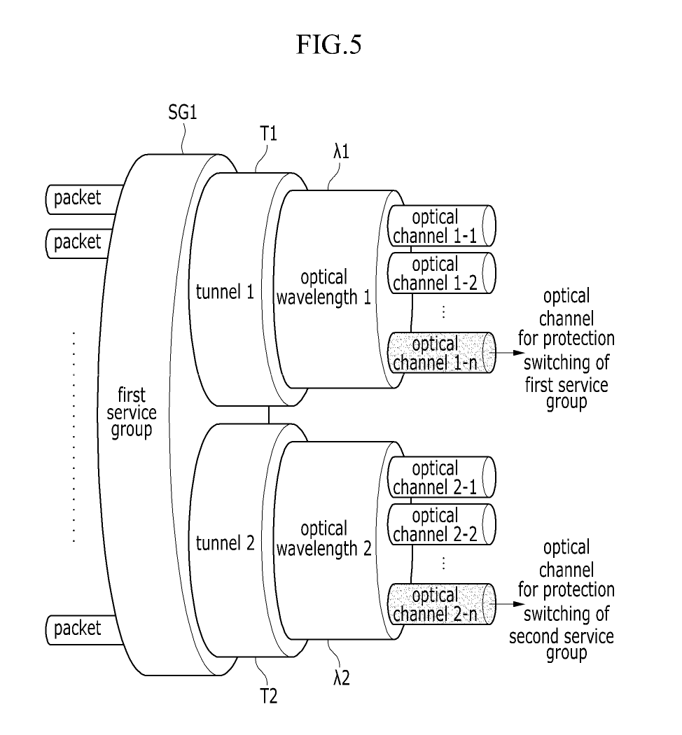

FIG. 4 is a flowchart showing a protection switching method in an optical transport network according to a first exemplary embodiment of the present invention, and FIG. 5 is an illustration of the application of the protection switching method according to the first exemplary embodiment of the present invention. Here, a plurality of tunnels are mapped to one service group as shown in FIG. 5, and the protection switching method according to an exemplary embodiment of the present invention will be described by taking an example of the first service group SG1.

A plurality of tunnels T1 and T2 are mapped to the first service group SG1 as illustrated in FIG. 5. In this case, referring to FIG. 2, a node 10 can be connected to a node 20 and a node 30 through the two tunnels T1 and T2 to transmit and receive packets corresponding to the first service group SG1. The packets included in the first service group SG1 are classified according to service level agreement (SLA), and then mapped to the corresponding optical channel and transmitted to the destination.

In this way, a plurality of tunnels are provided for one service group (e.g., SG1), each of the tunnels includes one optical wavelength, and the corresponding optical wavelength includes a plurality of corresponding optical channels (S100 and S110). One of the plurality of optical channels corresponding to each channel is set up as an optical channel for protection switching (S120). That is, as shown in FIG. 5, tunnel T1 mapped to the first service group SG1 includes one optical wavelength λ1, a plurality of optical channels 1-1, 1-2, . . . , 1-n are allocated to the optical wavelength λ1, and one 1-n of the plurality of optical channels 1-1, 1-2, . . . , 1-n is set up as an optical channel for protection switching. The other tunnel T2 mapped to the first service group SG1 includes one optical wavelength λ2, a plurality of optical channels 2-1, 2-2, . . . , 2-n are allocated to the optical wavelength λ2, and one 2-n of the plurality of optical channels 2-1, 2-2, . . . , 2-n is set up as an optical channel for protection switching. Therefore, one optical channel 1-n and 2-n for protection switching is set up for each tunnel for the first service group G1.

Afterwards, as shown in FIG. 2, packets corresponding to the first service group SG1 are transmitted and received between the node 10 and the node 20 through the optical channels 1-1, 1-2, . . . , 1-n-1 corresponding to tunnel T1, and are also transmitted and received therebetween through the optical channels 2-1, 2-2, . . . , 2-n-1 corresponding to tunnel T2 (S130).

At this point, if a failure occurs in an optical channel in packet transmission (S140), the packets transmitted through the optical channel in which the failure has occurred are transmitted through a preset optical channel for protection switching (S150).

More specifically, if a failure occurs in one optical channel 1-i (where i is an integer) while the packets corresponding to the first service group SG1 are being transmitted between the node 10 and the node 20 through the optical channels 1-1, 1-2, . . . , 1-n-1 constituting tunnel T1, the packets transmitted through the optical channel 1-i in which the failure has occurred are transmitted through a preset optical channel 1-n for protection switching. Moreover, if a failure occurs in one optical channel 2-i (where i is an integer) while the packets corresponding to the first service group SG1 are being transmitted through the optical channels 2-1, 2-2, . . . , 2-n-1, the packets transmitted through the optical channel 2-i in which the failure has occurred are transmitted through a preset optical channel 2-n for protection switching.

Therefore, packets can be transmitted through an optical channel for protection switching even in the event of a failure in an optical channel in an optical transport network, thereby ensuring the improvement of packet transmission quality.

Further, as an optical channel for protection switching is set up in advance, a different bandwidth can be allocated to each optical channel. As a result, traffic transmitted over the allocated bandwidth can be differentiated according to the operator's policy, thereby guaranteeing differentiated service quality.

In the exemplary embodiment of the present invention, examples of failures occurring in an optical channel include a path failure that makes transmission unavailable due to loss of connectivity of a path and path degradation that causes no problem in the connectivity of a path but degrades the quality of a connection state, and the detection of such failures is a well-known art, so a detailed description thereof will be omitted herein.

Next, a protection switching method in an optical transport network according to a second exemplary embodiment of the present invention will be described.

In the optical transport network according to the second exemplary embodiment of the present invention, a plurality of tunnels include one optical wavelength.

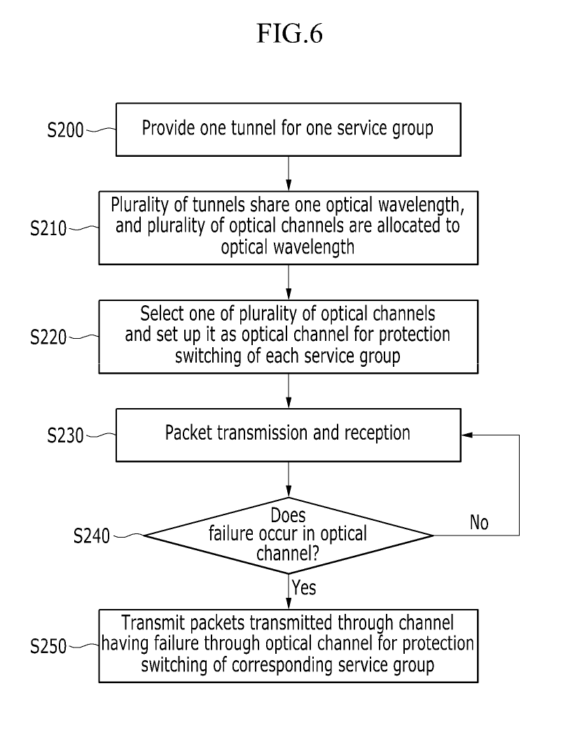

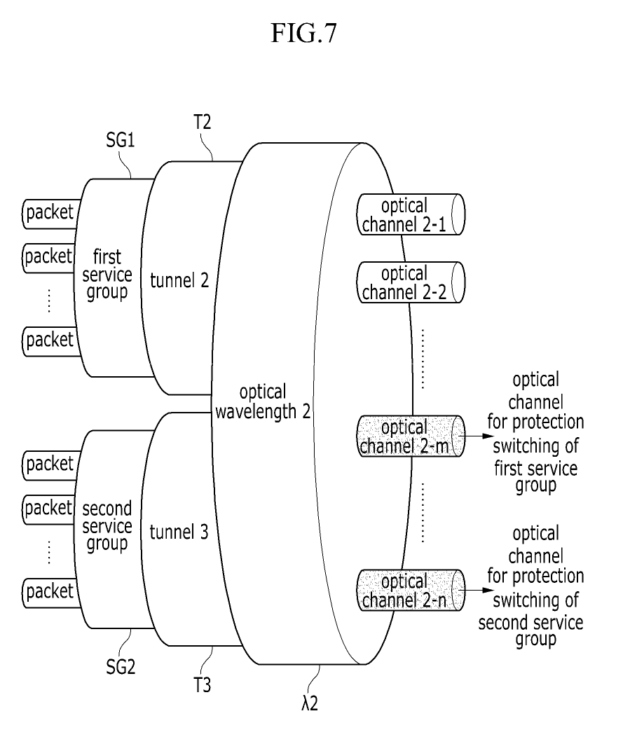

FIG. 6 is a flowchart showing a protection switching method in an optical transport network according to a second exemplary embodiment of the present invention, and FIG. 7 is an illustration of the application of the protection switching method according to the second exemplary embodiment of the present invention. Here, the protection switching method according to the second exemplary embodiment of the present invention will be described by taking an example of the first service group SG1 and second service group SG2 shown in FIG. 2. Here, one tunnel is mapped to each service group, and a plurality of tunnels mapped to the respective service groups uses one optical wavelength.

As shown in FIGS. 2 and 7, tunnel T2 is mapped to the first service group SG1, tunnel 3 is mapped to the second service group SG2, and packets corresponding to the first service group SG1 and the second service group SG2 are transmitted, for example, between the node 10 and the node 30. Here, the packets corresponding to the first service group SG1 are transmitted through tunnel T2, and the packets corresponding to the second service group SG2 are transmitted through tunnel T3.

In this way, if one tunnel is mapped to each service group (S200), tunnel T2 mapped to the first service group SG1 and tunnel T3 mapped to the second service group SG2 may include the same single optical wavelength λ2. That is, tunnel T2 and tunnel T3 share the same single optical wavelength λ2. A plurality of optical channels 2-1, 2-2, . . . , 2-n are formed for one optical wavelength λ2 corresponding to tunnel T2 and tunnel T3 (S210), and optical channels for protection switching corresponding to the respective service groups are set up on the basis of the optical channels 2-1, 2-2, . . . , 2-n (S220). That is, one optical channel 2-m is selected from among the optical channels 2-1, 2-2, . . . , 2-n corresponding to one optical wavelength λ2 and selected as an optical channel for protection switching of the first group SG1, and another optical channel 2-n is set up as an optical channel for protection switching of the second service group SG2.

Afterwards, the packets corresponding to the first service group SG1 and the packets corresponding to the second service group SG2 are classified according to SLA, and then transmitted to the destination through the remaining optical channels, except for the optical channels 2-m and 2-n for protection switching, among the optical channels 2-1, 2-2, . . . , 2-n (S230).

If a failure occurs in an optical channel in packet transmission while the packets corresponding to the first service group SG1 are being transmitted and received through the remaining optical channels, except for the optical channels for protection switching, through tunnel T2 (S240), the packets transmitted through the corresponding channel are transmitted through the optical channel 2-m for protection switching of the first service group SG1 (S250). Moreover, while the packets corresponding to the second service group SG2 are being transmitted and received through the remaining optical channels, except for the optical channels for protection switching, through tunnel T3, if a failure occurs in an optical channel in packet transmission, the packets transmitted through the corresponding optical channel are transmitted through the optical channel 2-n for protection switching of the second service group SG2.

Next, a protection switching method in an optical transport network according to a third exemplary embodiment of the present invention will be described.

In the optical transport network according to the third exemplary embodiment of the present invention, one tunnel includes a plurality of optical wavelengths.

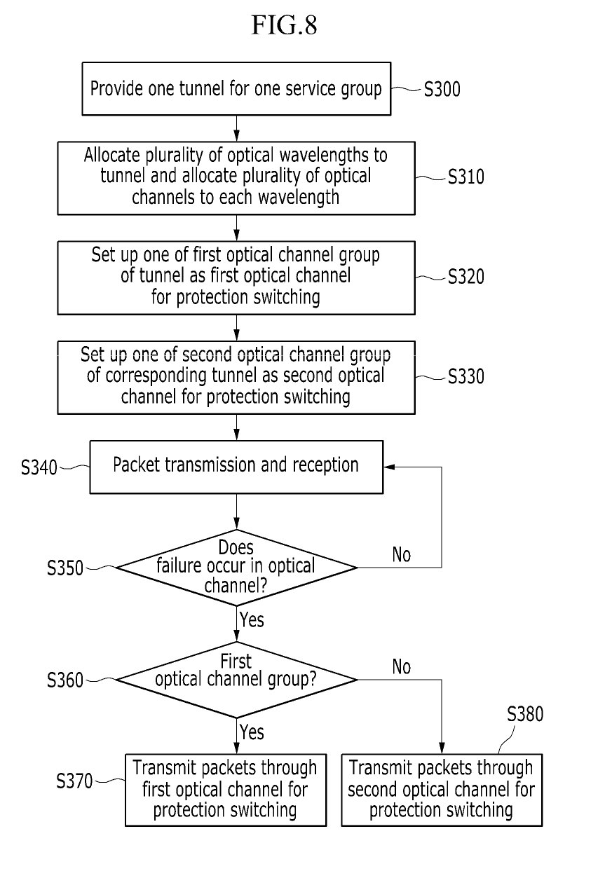

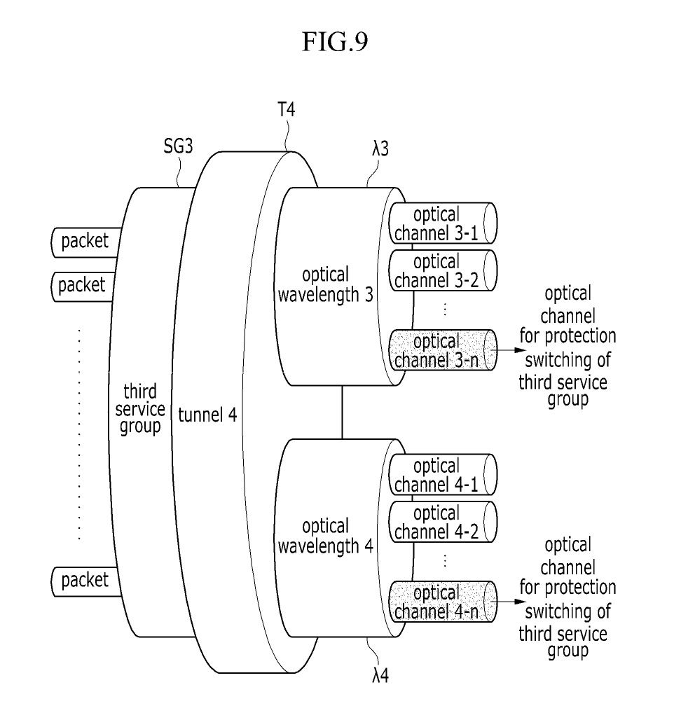

FIG. 8 is a flowchart showing a protection switching method in an optical transport network according to a third exemplary embodiment of the present invention, and FIG. 9 is an illustration of the application of the protection switching method according to the third exemplary embodiment of the present invention. Here, the protection switching method according to the third exemplary embodiment of the present invention will be described by taking an example of the third service group SG3 shown in FIG. 2.

As shown in FIGS. 2 and 9, packets corresponding to the third service group SG3 are transmitted between the node 10 and the node 40. Here, tunnel T4 is mapped to the third service group SG3, and the packets corresponding to the third service group SG3 are transmitted and received through tunnel T4.

Here, a plurality of optical wavelengths λ3 and λ4 are allocated to tunnel T4 mapped to the third service group SG3, and a plurality of optical channels are allocated to each optical wavelength. That is, a plurality of optical channels 3-1, 3-2, . . . , 3-n are allocated to the optical wavelength λ3 of tunnel T4, and a plurality of optical channels 4-1, 4-2, . . . , 4-n are allocated to the optical wavelength λ4 of tunnel T4 (S300 and S310). Hereinafter, for convenience of explanation, the plurality of optical channels 3-1, 3-2, . . . , 3-n allocated to the optical wavelength λ3 of tunnel T4 are referred to as a “first optical channel group”, and the plurality of optical channels 4-1, 4-2, . . . , 4-n allocated to the optical wavelength λ4 of tunnel T4 are referred to as a “second optical channel group”.

In this way, if one tunnel T4 includes a plurality of optical wavelengths λ3 and λ4, one of the optical channels corresponding to the respective optical wavelengths is set up as an optical channel for protection switching. That is, one optical channel 3-n of the first optical channel group 3-1, 3-2, . . . , 3-n of the optical wavelength λ3 constituting tunnel T4 of the third service group SG3 is set up as a first optical channel for protection switching for the third service group SG3 (S320), and one optical channel 4-n of the second optical channel group 4-1, 4-2, . . . , 4-n of the optical wavelength λ4 constituting tunnel T4 is set up as a second optical channel for protection switching for the third service group SG3 (S330).

In this way, optical channels for protection switching for the corresponding service group are set up for the respective optical wavelengths. Afterwards, the packets corresponding to the third service group SG3 are classified according to SLA, and then transmitted to the destination through the optical channels 3-1, 3-2, . . . , 3-n-1, except for the optical channel for protection switching, of the first optical channel group or through the optical channels 4-1, 4-2, . . . , 4-n-1, except for the optical channel for protection switching, of the second optical channel group (S340).

If a failure occurs in an optical channel in packet transmission, the packets transmitted through the optical channel in which the failure has occurred are transmitted through a preset optical channel for protection switching (S350). That is, if a failure occurs in one optical channel of the first optical channel group 3-1, 3-2, . . . , 3-n-1 of the optical wavelength λ3 constituting tunnel T4, the packets transmitted through the optical channel are transmitted through the first optical channel 3-n for protection switching set up for the first optical channel group (S360 and S370). Also, if a failure occurs in one optical channel of the second optical channel group 4-1, 4-2, . . . , 4-n-1 of the optical wavelength λ4, the packets transmitted through the optical channel are transmitted through the second optical channel 4-n for protection switching set up for the second optical channel group (S380).

Next, a protection switching method in an optical transport network according to a fourth exemplary embodiment of the present invention will be described.

In the optical transport network according to the fourth exemplary embodiment of the present invention, unlike the third exemplary embodiment, one tunnel includes a plurality of optical wavelengths, and, unlike the third exemplary embodiment, optical channels corresponding to one optical wavelength are all set up as optical channels for protection switching.

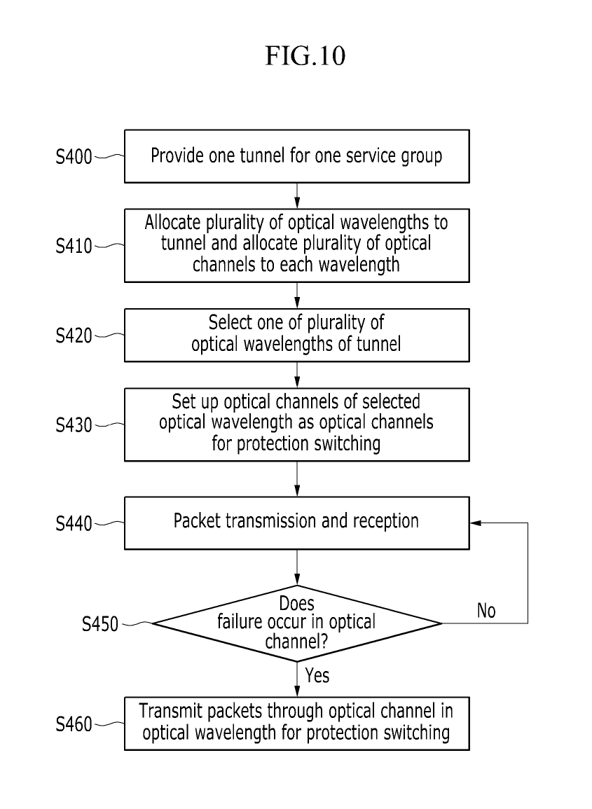

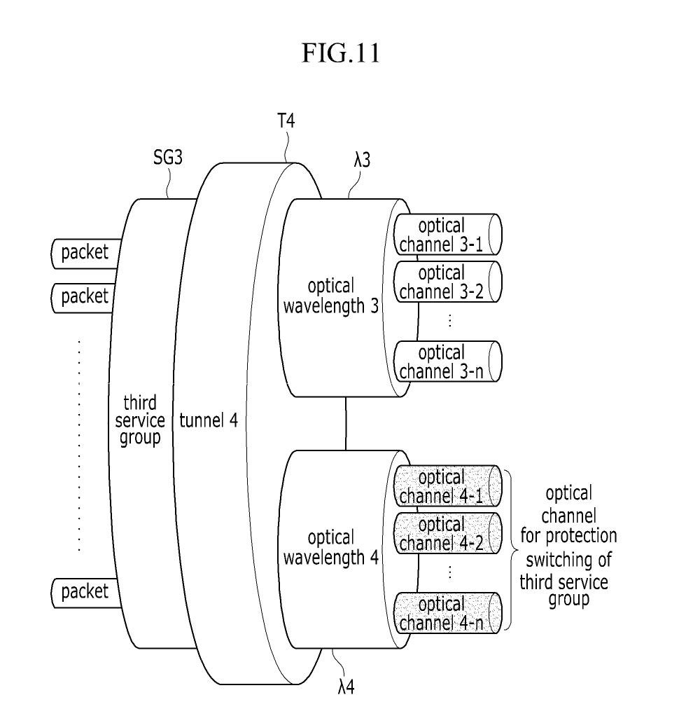

FIG. 10 is a flowchart showing a protection switching method in an optical transport network according to a fourth exemplary embodiment of the present invention, and FIG. 11 is an illustration of the application of the protection switching method according to the fourth exemplary embodiment of the present invention. Here, the protection switching method according to the fourth exemplary embodiment of the present invention will be described by taking an example of the third service group SG3 shown in FIG. 2.

In the optical transport network according to the fourth exemplary embodiment of the present invention, one tunnel includes a plurality of optical wavelengths. If one tunnel includes a plurality of optical wavelengths and a plurality of optical channels are allocated to each optical wavelength as previously described in the third exemplary embodiment, one of the plurality of optical wavelengths constituting one tunnel may be set up for protection switching, rather than setting up one protection switching channel for each optical wavelength as described above. That is, the plurality of optical channels corresponding to one optical wavelength are all set up as optical channels for protection switching.

In the fourth exemplary embodiment of the present invention, if one tunnel is mapped to one service group, as shown in the accompanying FIGS. 10 and 11, like in the third exemplary embodiment, the corresponding tunnel includes a plurality of optical wavelengths and a plurality of optical channels are allocated to each optical wavelength. That is, a plurality of optical wavelengths λ3 and λ4 are allocated to tunnel T4 mapped to the third service group SG3, the first optical channel group 3-1, 3-2, . . . , 3-n is allocated to the optical wavelength λ3, and the second optical channel group 4-1, 4-2, . . . , 4-n is allocated to the optical wavelength λ4 of tunnel T4 (S400 and S410).

Unlike the third exemplary embodiment, however, one of the optical wavelengths λ3 and λ4 of tunnel T4 is set up for protection switching (S420), and a plurality of optical channels corresponding to the set optical wavelength are set up as optical channels for protection switching (S430). That is, as shown in FIG. 10, the optical wavelength λ4 constituting tunnel T4 of the third service group SG3 is selected, and the corresponding second optical channel group 4-1, 4-2, . . . , 4-n is set up as optical channels for protection switching for the third service group SG3.

Therefore, the packets corresponding to the third service group SG3 are classified according to SLA, and then transmitted to the destination only through the optical channels (i.e., the first optical channel group 3-1, 3-2, . . . , 3-n) of the other optical wavelength not selected for protection switching (S440).

In this state, if a failure occurs in an optical channel of the first optical channel group in packet transmission, the packets transmitted through the optical channel in which the failure has occurred are transmitted through the optical channels for protection switching, i.e., optical channels of the second optical channel group (S450 and S460).

According to the exemplary embodiments of the present invention, in the case of packet transmission over an optical transport network, after establishing an end-to-end connection through a tunnel, a protection switching function is performed for a plurality of optical channels constituting the tunnel or for each optical wavelength, thereby making the protection switching function more effective and ensuring different packet transmission quality for each service.

Further, as an optical channel for protection switching is set up in advance, a different bandwidth can be allocated to each optical channel. As a result, traffic transmitted over the allocated bandwidth can be differentiated according to the operator's policy, thereby guaranteeing differentiated service quality.

The exemplary embodiments of the present invention are not implemented only by a device (object) and a method, but can be implemented through a program for realizing functions corresponding to the configuration of the protection switching method according to the exemplary embodiments of the present invention and a computer-readable recording medium having the program recorded thereon. Such implementation can be easily made by a skilled person in the art to which the present invention pertains from the above description of the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A protection switching method in an optical transport network including a plurality of nodes between which packets corresponding to at least one service group are transmitted and received, the method comprising:
forming an end-to-end connection by providing at least one tunnel for one service group, the tunnel including at least one optical wavelength;
allocating a plurality of optical channels to the optical wavelength; and
setting up at least one of the plurality of optical channels as an optical channel for protection switching of the service group.

2. The method of claim 1, wherein one tunnel is provided for one service group, the tunnel including a plurality of optical wavelengths, and
in the setting up, at least one of the plurality of optical channels for each optical wavelength is set up as an optical channel for protection switching of the service group.

3. The method of claim 1, wherein one tunnel is provided for one service group, the tunnel including a plurality of optical wavelengths, and
in the setting up, all of the plurality of optical channels corresponding to one of a plurality of optical wavelengths are set up as optical channels for protection switching of the service group.

4. The method of claim 1, wherein a plurality of tunnels are provided for one service group, each of the tunnels including a different optical wavelength, and
in the setting up, for each tunnel, at least one of the plurality of optical channels corresponding to the optical wavelength is set up as an optical channel for protection switching of the service group.

5. A protection switching method in an optical transport network including a plurality of nodes between which packets corresponding to at least one service group are transmitted and received, the method comprising:
forming an end-to-end connection by providing respective tunnels for different service groups, the tunnels of the different service groups including the same single optical wavelength;
allocating a plurality of optical channels to the single optical wavelength; and
selecting at least one of the plurality of optical channels for each service group and setting up the same as an optical channel for protection switching of each service group.

6. The method of claim 1, further comprising:
transmitting packets through the remaining optical channels, except for an optical channel for protection switching, among the optical channels corresponding to one tunnel; and
if a failure occurs in an optical channel in packet transmission, transmitting the packets through the optical channel for protection switching set up corresponding to the tunnel.

7. The method of claim 5, further comprising:
transmitting packets through the remaining optical channels, except for an optical channel for protection switching, among the optical channels corresponding to one tunnel; and
if a failure occurs in an optical channel in packet transmission, transmitting the packets through the optical channel for protection switching set up corresponding to the tunnel.

8. The method of claim 1, wherein the packets in a service group are classified according to service level agreement (SLA), and then transmitted to the destination through the optical channels of the tunnel mapped to the service group.

9. The method of claim 5, wherein the packets in a service group are classified according to service level agreement (SLA), and then transmitted to the destination through the optical channels of the tunnel mapped to the service group.

10. The method of claim 1, wherein different bandwidths are allocated to the optical channels.

11. The method of claim 5, wherein different bandwidths are allocated to the optical channels.

12. The method of claim 1, wherein an optical channel includes any of ODU (optical channel data unit), VC (virtual container), VCG (virtual concatenation group), and IP/service flow depending on what type of physical link it uses.

13. The method of claim 5, wherein an optical channel includes any of ODU (optical channel data unit), VC (virtual container), VCG (virtual concatenation group), and IP/service flow depending on what type of physical link it uses.
